(19) United States
(12) Patent Application Publication
(10) Pub. No.: US 2026/0346770 A1
(43) Pub. Date: Nov. 5, 2026

(54) CUSHION BODY

(71) Applicant: TOYOTA BOSHOKU KABUSHIKI KAISHA, Aichi-ken (JP)

(72) Inventors: Atsushi NITTA, Toyota-shi (JP); Shinnosuke KASUGA, Nisshin-shi (JP)

(73) Assignee: TOYOTA BOSHOKU KABUSHIKI KAISHA, Aichi-ken (JP)

(21) Appl. No.: 19/453,661

(22) Filed: Jan. 20, 2026

(30) Foreign Application Priority Data
Feb. 3, 2025 (JP) 2025-015929

(51) Int. Cl. B60N 2/58

(52) U.S. Cl. CPC B60N 2/5825; B60N 2205/35

(57) ABSTRACT

A cushion body for elastically supporting a seater includes three elements: a central portion that forms a central part in a seat width direction, and two side portions that form the respective side parts in the seat width direction. At least one of the divided elements comprises a base substrate that serves as a support base, a seat cover that directly or indirectly covers the base substrate from the front side of the seat, and a clip attached to the base substrate for hooking a portion of the seat cover. The clip has a clip base attached to a substrate surface of the base substrate and a hooking portion for hooking the seat cover. The base substrate has a mounting portion that enables the clip base to be snap-fit and pressed between the substrate surface and the mounting portion by sliding the clip base in a direction parallel to the substrate surface.

### CROSS-REFERENCE TO RELATED APPLICATION

This application claims priority to Japanese patent application serial number 2025-15929 filed Feb. 3, 2025, the contents of which are incorporated herein by reference in its entirety for all purposes.

### TECHNICAL FIELD

The present disclosure relates to a cushion body. In particular, the present disclosure relates to a cushion body that elastically supports a seater.

### BACKGROUND

Conventionally, there has been known a seat including a cushion body having a seat pad and a seat cover that covers the seat pad, wherein the seat is divided into three parts in a seat width direction. Specifically, the cushion body is divided into a central portion forming the central portion in the seat width direction and two side portions forming the side portions in the seat width direction.

The central portion and the two side portions are each covered with seat covers that enclose the seat pads. Each end of the seat cover is attached to a resin base substrate located on the backside of the seat pads. Furthermore, the seat cover is secured by being hooked onto clips that are mounted to the substrate through through-holes formed in the seat pad. Therefore, the central and side portions are configured such that each seat pad is sandwiched between the seat cover and the substrate.

In the configuration of the prior art, clips are mounted to the base substrate by snap-fitting from the rear side. Therefore, elastic claws with guide structures for attaching the clips from the rear side to the rear surface of the base substrate are designed to protrude significantly toward the back. Accordingly, the present disclosure provides a cushion body that enables compact attachment of clips for securing a seat cover to a base substrate.

### SUMMARY

In order to solve the above problem, the present disclosure has the following configuration.

A first aspect of the present disclosure relates to a cushion body that elastically supports a seater divided into three elements: a central portion forming a central part in a seat width direction, and two side portions forming respective side parts in the seat width direction. At least one of the divided elements comprises a base substrate serving as a support base, a seat cover that directly or indirectly covers the base substrate from the front side of the seat, and a clip attached to the base substrate for hooking a portion of the seat cover. The clip comprises a clip base attached to a substrate surface of the base substrate and a hooking portion for hooking the seat cover. The base substrate comprises a mounting portion that enables the clip base to be snap-fit and pressed between the substrate surface and the mounting portion by sliding the clip base in a direction along the substrate surface.

### BRIEF DESCRIPTION OF DRAWINGS

FIG. 1 is a perspective view showing a schematic configuration of a cushion body according to a first embodiment.

FIG. 2 is an exploded perspective view of the cushion body removed from a back frame.

FIG. 3 is an exploded perspective view of a central portion.

FIG. 4 is an enlarged view of part IV of FIG. 3.

FIG. 5 is an exploded perspective view of FIG. 4 with a clip removed from a main substrate.

FIG. 6 is a perspective view of the upper half of a main pad as viewed from the back side of the pad.

FIG. 7 is a cross-sectional view of the central portion taken along line VII-VII of FIG. 6.

FIG. 8 is a front view showing the relationship between a mounting portion of the clip and a soundproofing member.

FIG. 9 is a cross-sectional view of the central portion taken along line IX-IX of FIG. 8.

FIG. 10 is a cross-sectional view of the central portion taken along line X-X of FIG. 8.

### DETAILED DESCRIPTION

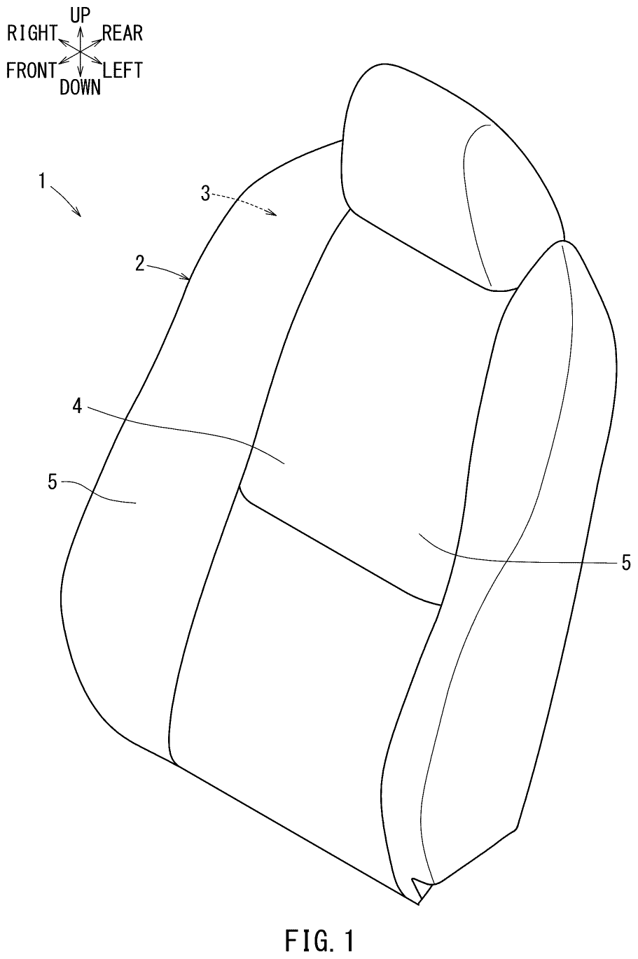

First, the configuration of a cushion body 2 according to a first embodiment of the present disclosure will be described with reference to FIGS. 1 to 10. In the following description, when directions such as front, rear, up, down, right, and left are indicated, these refer to the respective directions shown in each figure.

Furthermore, when directions are indicated with “seat” attached to each direction such as “seat width direction,” they refer to directions based on a seat back 1 described later. In addition, in the following description, when a specific reference drawing is not shown or when there is no reference numeral corresponding to the reference drawing, any one of FIGS. 1 to 10 shall be referred to as appropriate.

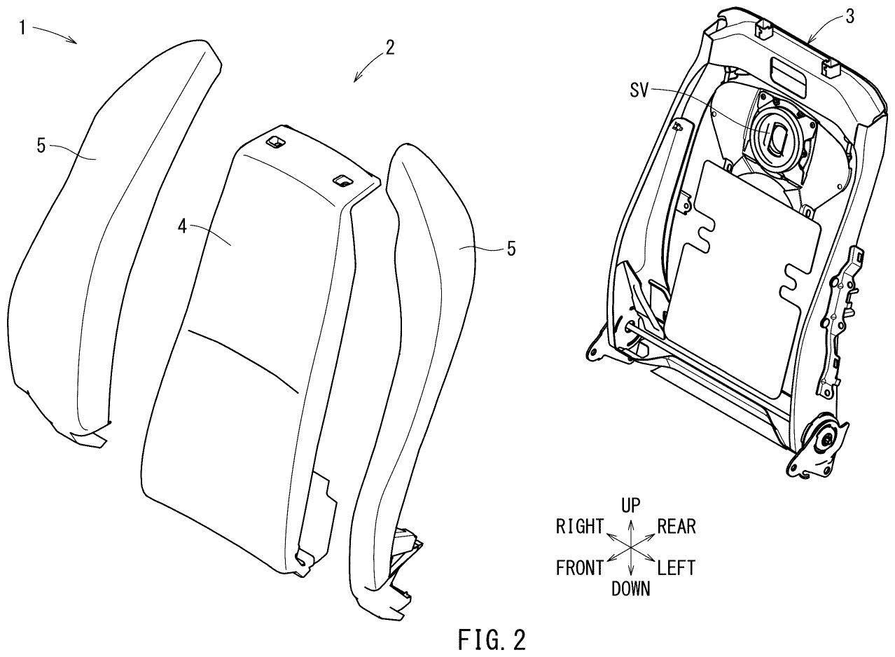

As shown in FIG. 1, the cushion body 2 according to the present embodiment is applied to the seat back 1 that forms a backrest portion of an automotive seat. As shown in FIG. 2, the seat back 1 has the cushion body 2 that elastically supports the back of a seater and a back frame 3 that supports the cushion body 2 from the rear side of the seat.

The cushion body 2 is configured to be divided into three elements: a central portion that forms a central portion in a seat width direction, and two side portions 5 that form both side portions in the seat width direction. The back frame 3 is made of a metal member assembled in a frame shape when viewed from the front.

Since the cushion body 2 is divided into the central portion 4 and each side portion 5 as described above, parts can be replaced according to specifications for each divided portion. The central portion 4 and each side portion 5 are individually assembled to the back frame 3 after assembling the respective component parts into one unit for each divided portion.

Specifically, each side portion 5 is integrally fixed to the back frame 3 by fitting with clips (not shown) or fastening with bolts. The central portion 4 is set so as to be fitted between them from the front of the seat after each side portion 5 is assembled to the back frame 3. Specifically, the central portion 4 is fixed such that its upper and lower portions are hooked to the upper and lower portions of the back frame 3.

The back frame 3 has a seat ventilator blower SV mounted in its upper area within the frame. The blower SV draws air in through the central portion 4 from the seat surface. By drawing air using the blower SV, air flows over the seat surface, thereby suppressing stuffiness during seating.

The central portion 4 and each side portion 5 have a common basic structure. Hereinafter, the configuration of each divided element of the cushion body 2 will be described in detail using the central portion 4 as an example.

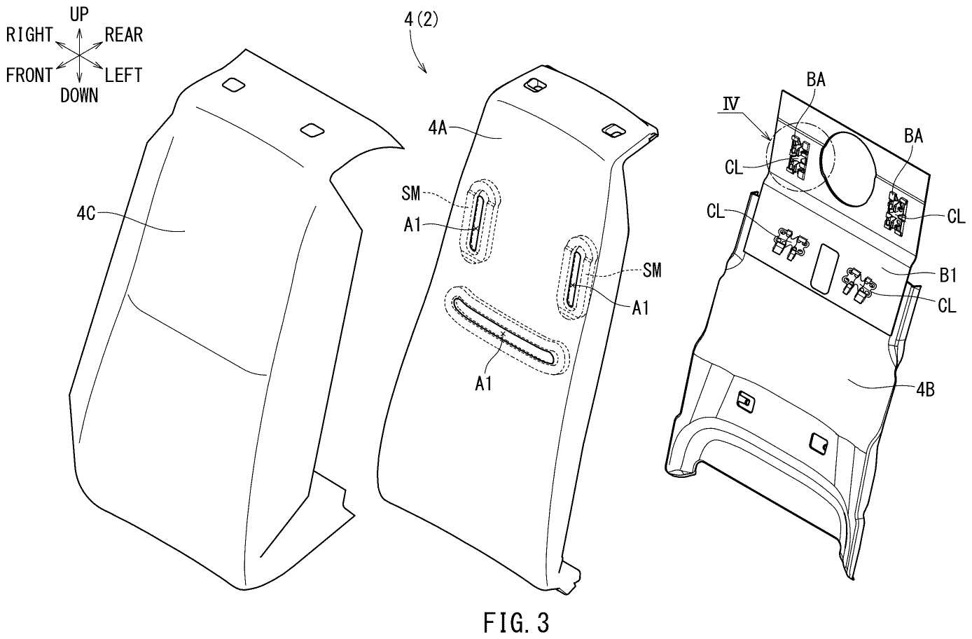

As shown in FIG. 3, the central portion 4 includes a main pad 4A made of foamed urethane and a main substrate 4B made of resin, which is disposed on the back surface of the main pad 4A. The central portion 4 also includes a main cover 4C made of fabric that covers the main pad 4A from the front surface side. The end of the main cover 4C is drawn into and secured to the back surface of the main substrate 4B.

The main cover 4C is integrated with the main substrate 4B such that the main cover 4C wraps the main pad 4A between the main cover 4C and the main substrate 4B. Thereby, the central portion 4 is assembled to form one module. Here, the main substrate 4B corresponds to the “base substrate” of the present disclosure, and the main cover 4C corresponds to the “seat cover” of the present disclosure.

The central portion 4 is integrally fixed by the main substrate 4B, which is provided on its rear surface and fitted onto the upper part of the back frame 3 (shown in FIG. 2) from above the seat. Furthermore, the central portion 4 is also integrally fixed by the lower end of the main cover 4C, which is pulled in from below into the lower part of the back frame 3 and hooked onto the underside of the seat.

As shown in FIG. 3, resin clips CL are attached to various locations on the main substrate 4B. These clips pull portions of the main cover 4C through a through-hole A1 formed in the main pad 4A and secure them in place. Each clip CL is snap-fitted into a corresponding mounting part BA formed in the main substrate 4B by being pressed into it.

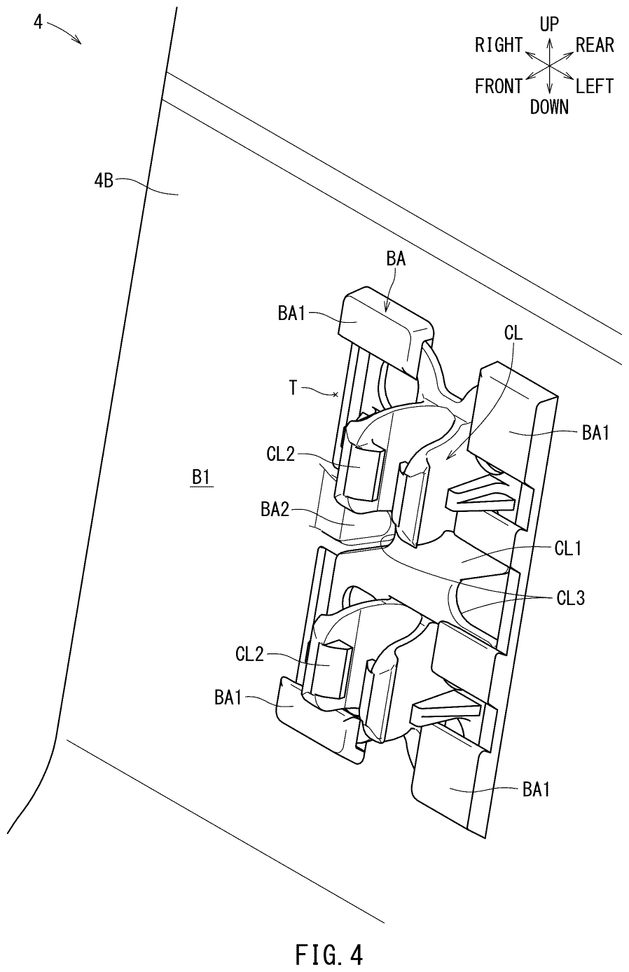

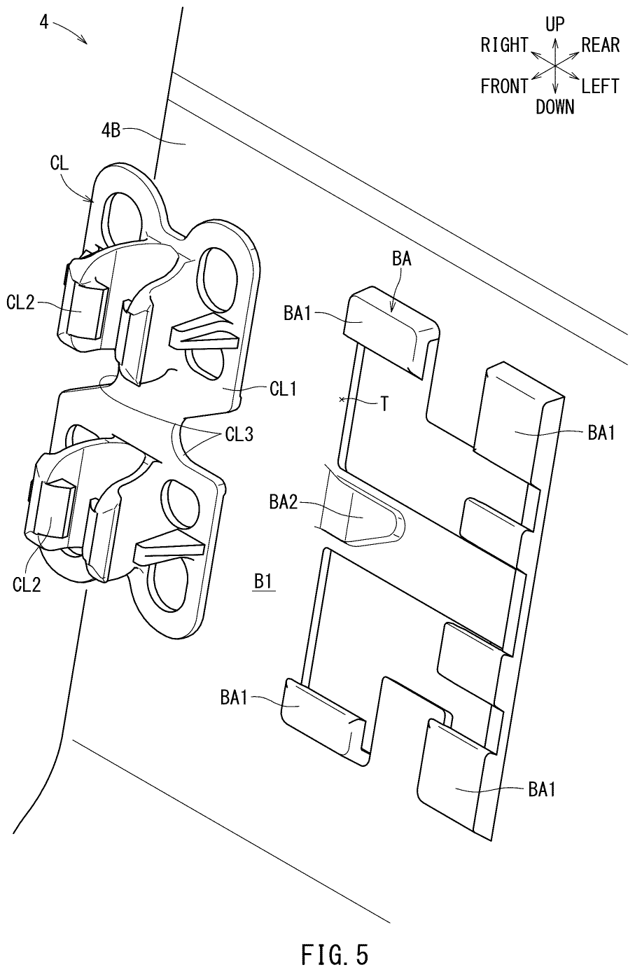

Next, the mounting structure of each clip CL to the main substrate 4B is detailed using the clip CL shown in FIGS. 4 and 5 as an example. The clip CL is secured to the mounting portion BA on the substrate surface B1 of the main substrate 4B, by insertion from the right side in the seat width direction. Thereby, the clip CL is fixed in a state of being pressed between the mounting portion BA and the substrate surface B1.

As shown in FIG. 5, the clip CL integrally comprises a flat plate-shaped clip base CL1, which serves as a base during mounting, and a hooking portion CL2 that protrudes forward from the clip base CL1 toward the front of the seat. The clip base CL1 is formed in a flat plate shape that is vertically elongated in front view.

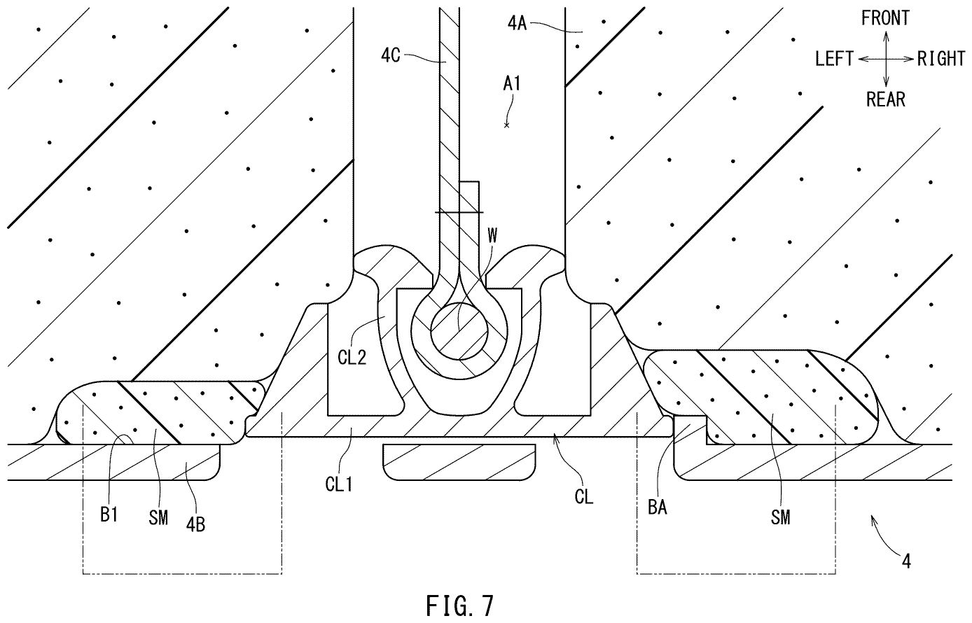

The hooking portion CL2 has a U-shape in a plan view and protrudes forward from two positions, an upper middle portion and a lower middle portion of the clip base CL1, toward the front of the seat. The tip of a hooking wire W (see FIG. 7), which is pulled in from the main cover 4C, is inserted into the U-shaped interior of the hooking portion CL2 from the front of the seat, thereby being snap-fitted in place.

The mounting portion BA includes a clamping portion BA1 that presses the four corners of the clip base CL1 between the clamping portion BA1 and the substrate surface B1. The clamping portion BA1 protrudes from the substrate surface B1 in a hook-shaped configuration and presses the four corners of the clip base CL1 from the front side of the seat. An opening T is formed between the clamping portion BA1 and the substrate surface B1, through which the clip base CL1 can be inserted by sliding it parallel to the substrate surface B1 from the right side in the seat width direction.

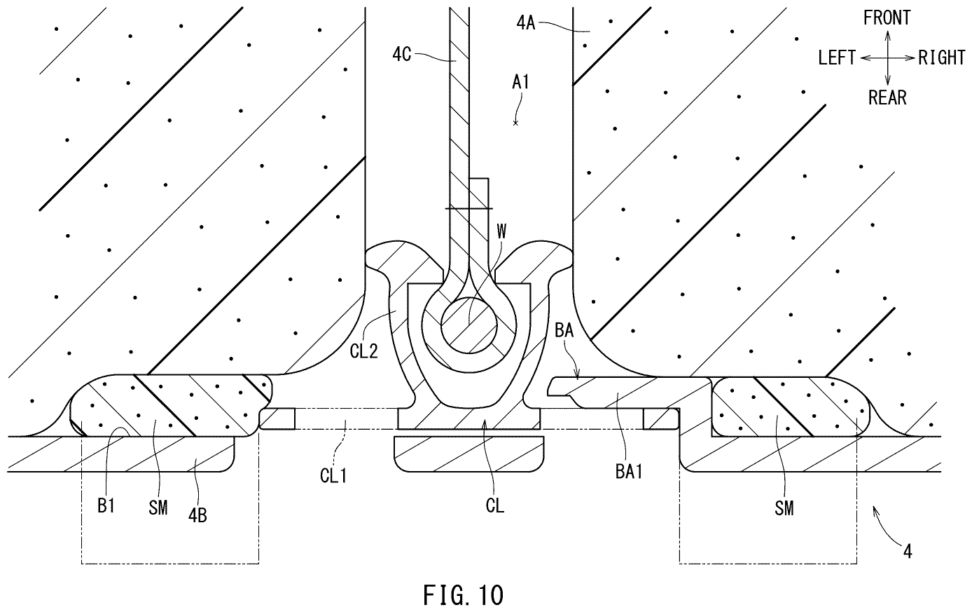

The clamping portion BA1 engages the clip base CL1 by contacting two of its corners at the insertion destination when the clip base CL1 is inserted to a position where all four corners are pressed along the substrate surface B1 (see FIGS. 4 and 10). The mounting portion BA includes a raised portion BA2 that causes the clip base CL1 to be inserted while being bent in an arc between the clip base CL1 and the clamping portion BA1 during insertion of the clip base CL1 described above.

The raised portion BA2 is formed to extend from the substrate surface B1 of the main substrate 4B. Specifically, it protrudes from the substrate surface B1 at a central portion between the two corners on the entrance side of the clamping portion BA1, where the clip base CL1 is inserted.

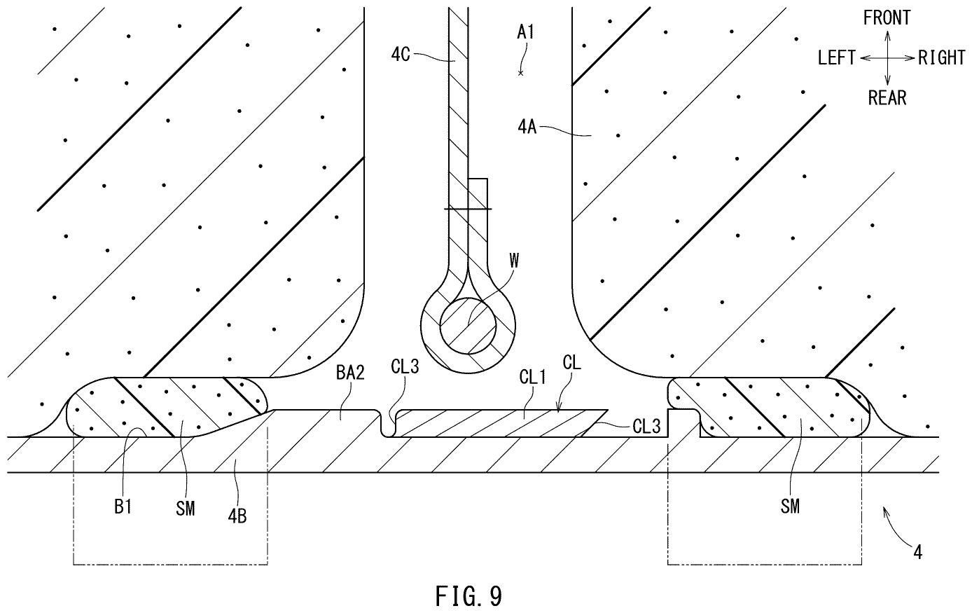

The raised portion BA2 is formed to extend at an incline from the substrate surface B1 of the main substrate 4B, allowing the clip base CL1 to ride up from the substrate surface B1 during insertion. Furthermore, the raised portion BA2 is positioned to restore the curvature of the clip base CL1 when it reaches the position where it is clamped at all four corners by the clamping portion BA1 (see FIGS. 5 and 9).

As shown in FIG. 5, the clip base CL1 has a shape with constrictions CL3 on both sides of its longitudinal center. Consequently, when the clip base CL1 is inserted from the right side in the seat width direction into the opening T between the clamping portion BA1 and the substrate surface B1, its upper and lower ends first enter between the two front corners of the clamping portion BA1 and the substrate surface B1. The constrictions CL3 allow the clip base CL1 to avoid interference with the raised portion BA2 during insertion.

Subsequently, as insertion progresses, the clip base CL1 rides over the raised portion BA2. Consequently, the clip base CL1 is inserted between the clamping portion BA1 and the substrate surface B1 while arching like a bow. This occurs due to the clamping of both ends by the two front corners of the clamping portion BA1 and the riding over of the raised portion BA2 at the center portion.

At this time, the hooking portion CL2, which extends from the clip base CL1, passes between the two right-side corners of the clamping portion BA1 to avoid interference. As shown in FIG. 4, the clip base CL1 is fully inserted when its four corners are clamped by the clamping portion BA1, which allows it to descend from the raised portion BA2 and restore its curvature. The raised portion BA2 then acts as a stopper to prevent the clip base CL1 from slipping outward in the seat width direction. This configuration leaves the clip seat CL1 securely clamped between the mounting portion BA and the substrate surface B1 (see FIG. 10).

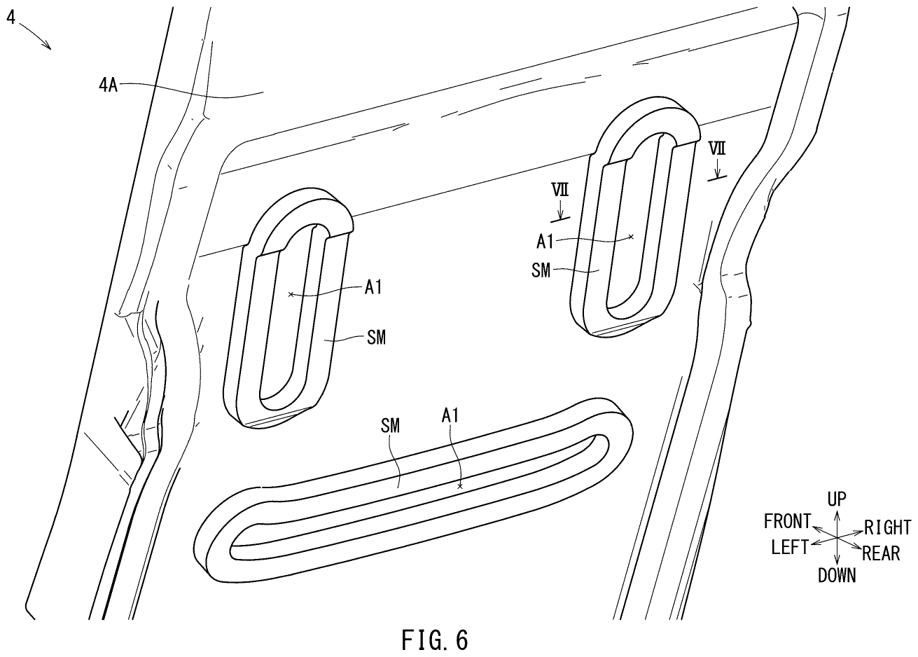

As shown in FIGS. 6 and 7, the main cover 4C is inserted into the rear side of the seat through the corresponding through-holes A1 formed in the main pad 4A. If a gap exists between the main pad 4A and the main substrate 4B, the operating noise of the blower SV (described in FIG. 2) may be transmitted to the occupant through the through-holes A1.

In order to suppress the transmission of such noise, sponge-based soundproofing members (SM) are disposed on the rear surface of the main pad 4A so as to individually surround each through-hole A1. Each soundproofing member SM is affixed to the rear surface of the main pad 4A by means of double-sided tape. Alternatively, each soundproofing member SM may be bonded to the rear surface of the main pad 4A using an adhesive.

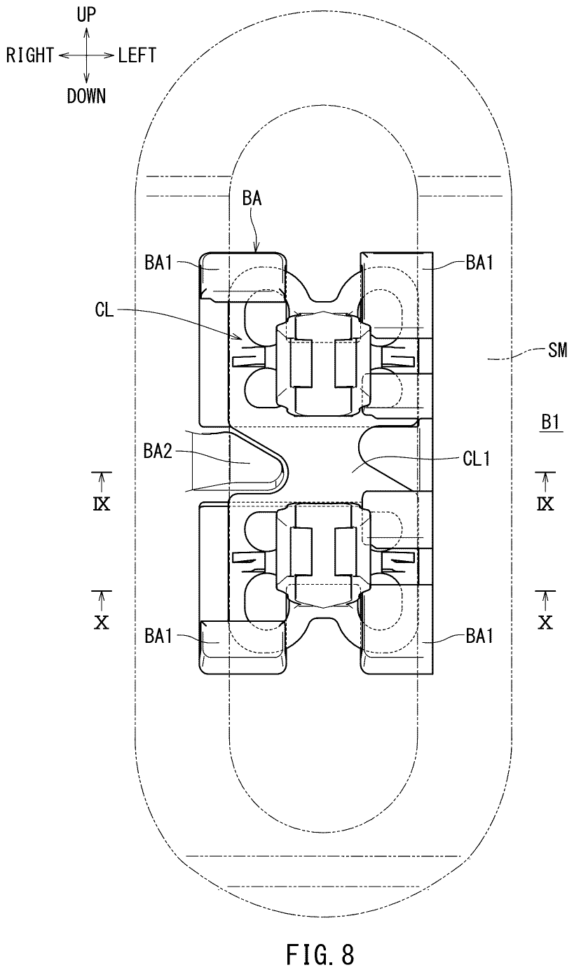

As shown in FIG. 7, each soundproofing member SM is pressed against the front surface of the main substrate 4B when the central portion 4 is assembled into a single module. Specifically, as shown in FIG. 8, since each soundproofing member SM is disposed to surround a respective through-hole A1, it is pressed against the clamping portion BA1 and the area surrounding the clamping portion, and is laid over the clamping portion BA1 located at each of the four corners of the main substrate 4B.

Accordingly, each soundproofing member SM is compressed into a shape conforming to the uneven profile defined by the protrusion extending from the substrate surface B1 of the clamping portion BA1 and the recess located between the four corners of the clamping portion BA1. Therefore, as shown in FIG. 7, the gap between the main pad 4A and the main substrate 4B is effectively filled by each soundproofing member SM.

Each soundproofing member SM is configured to be attached to the rear surface of the main pad 4A, thereby facilitating accurate positioning so as to surround each through-hole A1. Furthermore, by employing a sponge material having a porous structure as the soundproofing member SM, sound leakage can be effectively suppressed. In addition, each soundproofing member SM can be appropriately compressed to conform to the shape of the gap between the main pad 4A and the main substrate 4B, thereby enabling effective suppression of sound leakage irrespective of the shape of the gap.

To summarize the above, the cushion body 2 according to the present embodiment has the following configuration. The reference numerals shown in parentheses below correspond to the respective components shown in the above embodiment.

That is, the cushion body (2) has a configuration divided into three divided elements: a central portion (4) forming a central part in a seat width direction, and two side portions (5) forming respective side parts in the seat width direction. At least one of the divided elements comprises a base substrate (4B) serving as a support base, a seat cover (4C) that directly or indirectly covers the base substrate (4B) from the front side of the seat, and a clip (CL) attached to the base substrate (4B) for hooking a portion of the seat cover (4C).

The clip (CL) comprises a clip base (CL1), which attaches to the substrate surface (B1) of the base substrate (4B), and a hooking portion (CL2) for hooking the seat cover (4C). The base substrate (4B) has a mounting portion (BA) that enables the clip base (CL1) to be snap-fit and pressed between the substrate surface (B1) and the clamping portion (BA1) by sliding the clip base (CL1) in a direction along the substrate surface (B1).

Accordingly, by providing the mounting portion (BA) on the base substrate (4B) that is configured to receive the clip base (CL1) in a direction parallel to the substrate surface (B1) and engage it via a snap-fit mechanism, the substrate surface (B1) of the base substrate (4B) can serve as a guide for attachment. Therefore, the protrusion of the mounting portion (BA) from the base substrate (4B) can be minimized, thereby enabling a compact configuration.

Further, the mounting portion (BA) secures the clip base (CL1) through a slide-and-lock mechanism. The mounting portion (BA) includes a clamping portion (BA1) and a raised portion (BA2). The raised portion (BA2) protrudes from the substrate surface (B1). As the clip base (CL1) slides into the clamping portion (BA1) parallel to the substrate (B1), the raised portion (BA2) causes the clip base (CL1) to deflect. The clip base (CL1) is inserted beyond the raised to restore its deflection, which then is pressed and retained between the clamping portion (BA1) and the substrate surface (B1). Accordingly, by configuring the clip base (CL1) to be deflected instead of the mounting portion (BA) of the base substrate (4B), the structural integrity of the base substrate (4B) can be maintained, and the clip base (CL1) can be securely mounted.

Further, the substrate surface (B1) of the base substrate (4B) on which the clip base (CL1) is mounted constitutes the surface of the base substrate. According to the above configuration, since it is not necessary to provide a hole in the base substrate (4B) for passing the hooking portion (CL2) of the clip (CL) from the back side, the mounting portion (BA) can be configured more simply.

The cushion body of the present disclosure can also be applied to seats of vehicles other than automobiles, such as railways, aircraft, ships. The cushion body can also be applied to non-vehicle seats installed in various facilities such as sports facilities, theaters, concert halls, event venues, in addition to vehicles. The cushion body can also be applied to seat structures other than seat cushions, such as headrests, ottomans, armrests.

The cushion body may be configured without a seat pad, where the seat cover directly covers the base substrate. Alternatively, the cushion body may be configured with a thin elastomer or urethane sub-cover cushion provided on the surface of the base substrate instead of a seat pad.

The divided portion of the cushion body to which clips for hooking the seat cover from the base substrate are attached may be the side portion. The mounting portion formed in the base substrate may be one where the clip base is inserted by deflecting it and then restored, or one where the clip base is snap-fitted with flexing of the retaining portion.

The mounting portion may also be configured to snap-fit the clip base by sliding it in a direction parallel to the seat base, thereby pressing the clip base between the seat base and the mounting portion. Specifically, the mounting portion may be configured to snap-fit the clip base by sliding it not only in the seat width direction on the seat back, but also in the seat height direction. This configuration may likewise be applied to other seat structures.

The mounting portion may also be formed to mount the clip base to the back surface (substrate surface) of the base substrate. In such a case, it is necessary to provide a hole in the base substrate to allow the hooking portion of the clip to pass from the rear side to the front side. Furthermore, the hole must be configured to permit the hooking portion to slide therethrough, thereby enabling the clip base to slide in a direction parallel to the substrate surface and engage with the mounting portion via snap-fit.

Another aspect of the present disclosure relates to a cushion body. The mounting portion includes a clamping portion configured to allow insertion of a clip base by sliding it in a direction parallel to the substrate surface, such that the clip base is pressed between the substrate surface and the clamping portion. The mounting portion further includes a raised portion that protrudes from the substrate surface and causes the clip base to bend between the clamping portion and the raised portion during insertion. When the clip base is inserted beyond the raised portion, it returns to its original shape and is clamped between the clamping portion and the substrate surface.

According to the above aspect, by designing the structure such that the clip base is bent instead of the clamping portion of the base substrate, the structural integrity of the base substrate can be maintained, thereby enabling the clip base to be securely attached.

Another aspect of the present disclosure is a cushion body, wherein the substrate surface of the base substrate onto which the clip base is mounted is a front surface of the base substrate.

According to the above aspect, since it is not necessary to form a hole in the base substrate for allowing the hooking portion of the clip to pass from the rear side, the mounting portion can be configured in a simpler manner.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved cushion body, and/or methods of making and using the same.

We claim:

1. A cushion body that elastically supports a seater being divided into three elements, comprising:
a central portion forming a central part in a seat width direction; and
two side portions forming respective side parts in the seat width direction, wherein at least one of the three elements comprising:
a base substrate serving as a support base;
a seat cover that directly or indirectly covers the base substrate from a front side of the seat; and
a clip attached to the base substrate for hooking a portion of the seat cover,
wherein the clip further comprises a clip base attached to a substrate surface of the base substrate and a hooking portion for hooking the seat cover;
a mounting portion located on the base substrate and configured for the clip base to be snap-fit and secured by sliding the clip base in a direction parallel to the substrate surface.

2. The cushion body according to claim 1, wherein the mounting portion comprises:
a clamping portion configured to allow insertion of the clip base by sliding it parallel to the substrate surface, such that the clip base is pressed between the substrate surface and the clamping portion; and
a raised portion that protrudes from the substrate surface and causes the clip base to bend between the clamping portion and the raised portion during insertion,
wherein the insertion of the clip base beyond the raised portion causes the clip base to return its original shape and be clamped between the clamping portion and the substrate surface.

3. The cushion body according to claim 2, wherein the substrate surface of the base substrate onto which the clip base is mounted is a front surface of the base substrate.

4. The cushion body according to claim 1, wherein the clip base comprises constrictions located on both sides of longitudinal center of the clip base, and wherein the clip base is configured to avoid interference with the raised portion during the insertion.

5. The cushion body according to claim 1, further comprising:
a main pad having a through-hole for passage of the seat cover portion; and
a soundproofing member disposed on a rear surface of the main so as to individually surround the through-hole, wherein the soundproofing member is compressed against a from surface of the base substrate when the at least one divided element is assembled to suppress the transmission of operating noise from a seat ventilator blower.

6. A cushion body being divided into three elements, comprising:
a central portion that forms a central part in a seat width direction; and
two side portions forming respective side parts in the seat width direction, wherein at least one of the three divided elements comprising:
a base substrate serving as a support base;
a seat cover that directly or indirectly covers the base substrate from a front side of the seat;
a clip attached to the base substrate for hooking a portion of the seat cover,
wherein the clip further comprises a clip base attached to a substrate surface of the base substrate and a hooking portion for hooking the seat cover;
a mounting portion located on the base substrate and configured for the clip base to be snap-fit and secured by sliding the clip base in a direction parallel to the substrate surface; and
a soundproofing member surrounding a through-hole in the cushion body for suppressing noise transmission from a seat ventilator blower.

7. The cushion body according to claim 6, wherein the mounting portion comprises a clamping portion configured to press the clip base between the clamping portion and the substrate surface.

8. The cushion body according to claim 7, wherein the clamping portion protrudes from the substrate surface in a hook-like shape.

9. The cushion body according to claim 7, wherein the clamping portion has an opening formed between the clamping portion and the substrate surface that enables the clip base to slide in a direction parallel to the substrate surface.

10. The cushion body according to claim 6, wherein the mounting portion further includes a raised portion configured to cause the clip base to bend in an arc during insertion.

11. The cushion body according to claim 6, wherein the soundproofing member is made of material with a porous structure.
